(19) United States
(12) Patent Application Publication
(10) Pub. No.: US 2007/0059410 A1
(43) Pub. Date: Mar. 15, 2007

(54) Method and equipment embodiment for disinfection and preservation of foodstuffs and other products by means of o3 o2 co2 argon, uv-c light and ultrasound in vacuo

(76) Inventor: Hanspeter Steffen, Utzenstorf (CH)

Correspondence Address: BIRCH STEWART KOLASCH & BIRCH, PO BOX 747, FALLS CHURCH, VA, 22040-0747, US

(21) Appl. No.: 10/554,446

(22) PCT Filed: Apr. 26, 2004
(86) PCT No.: PCT/CH04/00253

§ 371 Date: Oct. 11, 2006

(30) Foreign Application Priority Data
Apr. 25, 2003 (CH) 74103

(51) Int. Cl. A23L 3/3409

(52) U.S. Cl. 426/236

(57) ABSTRACT

Disinfection method for foodstuffs and equipment embodiment using O₃, O₂, CO₂ and Ar, with application of UV-C radiation (UV-C lamps (3A), ultrasound (ultrasound transducer 16A) and vacuum (vacuum pump 2A).

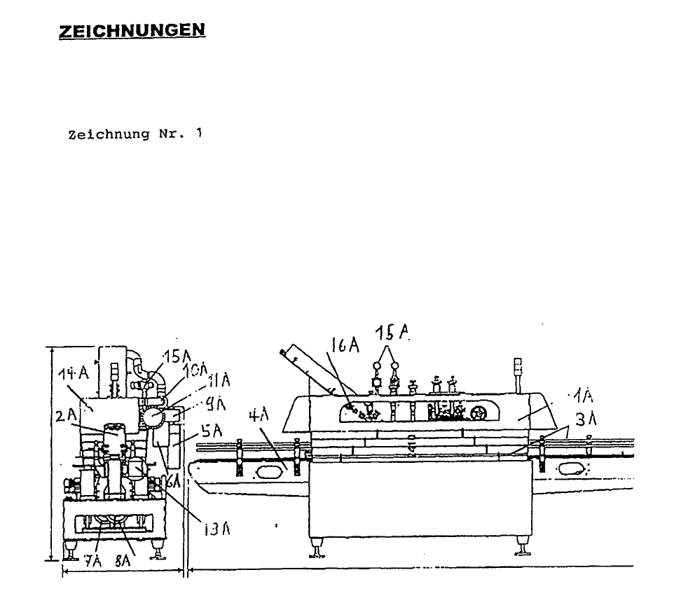

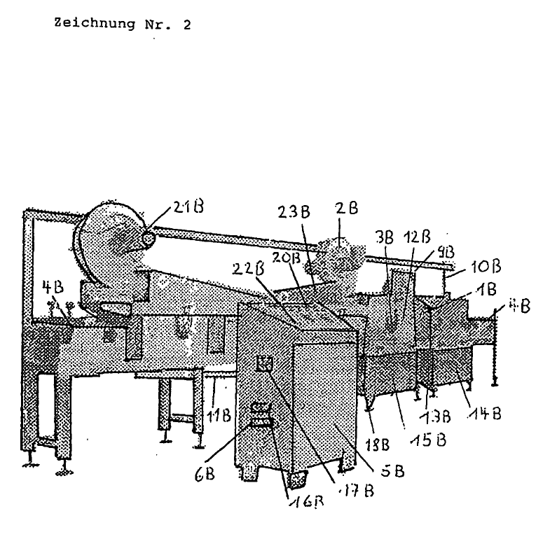

### TECHNICAL FIELD

The invention concerns a new disinfection method and its technical implementation

for the cold sterilization and conservation of fruits, vegetable, flowers, agriculture and horticultural products, food stuff and other products with the aid of Vacuum-Technology, Ozone, Oxygen, Carbondioxyde, Argon, UV-C Light-Irradiation and Ultrasound, according to the preamble of the independent patent claims.

### STATE OF THE ART

With the advancement of the ecological production in agriculture more and more problems emerge worldwide regarding the microbiological contamination of agricultural products and food stuff because of the intense use of animal excrements and by-products for the fertilization and the total application abstinence of fungicides, bactericides and pesticides.

In the last few years diseases caused by food stuff contaminated with pathogenic microbes are

increasing a lot, worldwide.

Pathogens like salmonella, shigella, listeria, E. coli and enterobacteria on fruits and vegetables cause more and more infectious diseases in consumers.

At the same time, the risk of terror attacks with micro organisms like anthrax, botulinum through the food chain is increasing substantially, according to information of secret services.

Respective preventive actions for a decontamination and disinfection and for a packaging to enclose fruits and vegetables and other fresh food stuff are therefore compulsory to guarantee the food security for consumers of fresh products.

Until today treatments with washings and bathes which contain i.a. chlorine are used for this purpose.

The use of chlorine, because of its carcinogenic action, and its environmental damage of chlorine in effluents, and its negative organoleptic odour are heavily contested and therefore unacceptable.

Furthermore chlorine causes resistance in microbes and the efficiency of chlorine is

therefore uncertain.

Other methods of disinfections, as for instance, with hot steam, have product-quality loss as a consequence.

Irradiation with gamma-irradiation and with pulsed magnetic field methods are often prohibited or require a permission and label-declaration.

The use of ozone is a new technology, which has been granted permission since 26 Jun. 2001 in USA, Japan etc., but which provides unsatisfactory biocidal results, if applied as single disinfection method alone.

The use of UV-radiation works only where the radiation has direct surface-contact with the product to be disinfected. Microbes in cavities or at the underside of leafs or the calyx can not be reached.

The use of ultrasound causes the braking-up of cell-walls and plastids.

Microbes possess often the capability to repair such brake-ups with the aid of special biological survival strategies.

The only use of ultrasound for sterilization purpose is therefore insufficient.

All mentioned methods show, in a single application only, unsatisfactory results.

### DESCRIPTION OF THE INVENTION

Aim of the invention is the demonstration of a new process and its technical implementation for the cold sterilization and conservation of fruits and vegetables, agricultural and horticultural products, food stuff and other products with the aid and simultaneous use of Vacuum, Ozone, Oxygen, Carbondioxyde, Argon and UV-C Light and Ultrasound.

The inventor has demonstrated in 10 year-long research-work in the laboratory and in industrial applications that with the new disinfection method with the special chemical and technical innovative application-combination of biocides, excellent

microbial results can be achieved regarding aseptic and conservation-capability of fresh food stuff and other products.

### INTRODUCTION

Ozone O3

Ozone, O3 is the 3 atomic form of oxygen.

Ozone is highly reactive and the most powerful known oxidation media. It is 51 times more reactive than chlorine and 3125 times faster in the destruction of microorganisms.

Ozone is a highly unstable molecule in gaseous form which disintegrates in a short period of time (half-life time ca. 20 minutes) again in oxygen O2.

Ozone is created by UV-C radiation or by Corona cathodic discharge with approximately 7,000 volts.

Ozone is better soluble in water than oxygen.

Ozone is a gas of bluish color, heavy smelling and with an exposition concentration of 0.1 mg per m3/air unproblematic for permanent exposure.

Ozone reacts through the splitting of an oxygen atom when having contact with organic or inorganic compounds and leads through the formation of Hydroxyl-Radicals to an oxidation respectively to a dissolution of cell walls and membranes of eucariontes which are resulting in the destruction of fungus, bacteria, virus, spores and yeast, and which are blocking and paralyzing the respiration organs of insects which consequently results in death.

Ozone cannot dissolve the multilayered structures of cell walls of plants. Ozone can therefore not penetrate into plants excepting in long exposure via the respiration stomata.

where it creates in the plant System Acquired Resistance (SAR).

Ozone alone works in a short contact principal and has itself no systemic effect.

Ozone does not give residues since it disintegrates in a short period of time again in oxygen.

Ozone leaves no damaging effects on plants or foodstuff because of its short action time.

Also, ozone creates no resistances in microbes or plant pathogens.

Ozone is not cancinogenic.

Ozone is therefore, a most effective biocide against fungus, bacteria, virus, yeast, bio-films and protozoa and higher creatures like insects, worms, aphids and other pathogenic parasites.

Ozone is permitted by the FDA (Food and Drug Administration) as additive since the 26 Jun. 2001 in direct contact with foodstuff.

Ozone is also permitted by EPA (Environment Protection Agency) in USA as a disinfection product.

UV-Light

UV-C Light as electromagnetic direct radiation has its optimal biocidal effect in the wave length range of 254 nanometers against bacteria, yeast, virus and insects.

The irradiation provokes in microorganisms a dissolution of cell-membranes and is destructive to DNA structures.

In the wave length range of 185 nanometers UV-C radiation creates ozone which under the influence of high humidity generates high oxidative unstable hydroxyl radicals which amplify the action of Ozone as a biocide.

(Micro Biotic Hurdel Principle)

UV-C irradiation of foodstuff is permitted by the FDA USA (Food and Drug

Administration) since 1997 and for vegetable foodstuff and cheese etc. also in the radiation

protection regulation of Germany.

For the efficiency of the UV-C irradiation, the radiation dose is essential, which is expressed in mW/sec/cm2 (Millie Watt per second per square centimeters of irradiated surface).

The dose to eliminate microorganisms is preferentially 4,000 to 15,000 mW/sec/cm2 (depending on the species).

Insects ca. 500,000-1,500.000 mW/sec/cm² (depending on species)

Carbondioxyde

CO2 has a toxic effect on aerobe microorganisms and insects in a concentration of more than 30% and prevents the multiplication of microorganisms in a concentration of 15 to 20% and higher.

Simultaneously, CO2 in high concentrations of more than 4% reduces the cellular respiration of fruits and vegetables and blocks the breathing stomata and, hence, prevents the ozone gas from entering the vegetable cells.

Argon

Argon is a noble gas and is in concentration of preferentially 10% acting as catalyst and increases the activity of CO2 and Ozone.

Ultrasound

Ultrasound, generated by a transducer, with a wave-length of 20 kHz (kilo-herz) up to 100 kHz (kilo-herz), destroys cell-walls of bacteria, fungus, and yeast and plast-ides and has through the phenomenon of cavitation, an increased effect for the disinfection gases, and dissolves as well bio-films on surfaces with the principle of suction.

Vacuum

The use of a vacuum below 50 mbar (mill bar) tiers apart cell-membranes of microbes and insects and supports the efficiency of CO2 and Ozone and UV-Light.

At the same time the vacuum causes the impregnation and the penetration of the injected biocide-gases in the products to be disinfected.

The invention of the new disinfection- and sterilization-method consists essentially in the new combination-application of Ozone, Oxygen, Carbondioxyde,

Argon, UV-C Light, Ultrasound and Vacuum and the applied technology together with the corresponding technical equipment and its special way of functioning.

With the hurdle-principle, microbes are exposed simultaneously to several biocides, in such a way, that defense and protection-mechanisms and resistance-strategies collapse because of overstress at the energy and defense systems, resulting in death of the microbes.

The new sterilization- and conservation-method consists in a first embodiment version of the following technical main-components:

1A Vacuum-tunnel with hydraulic vacuum-chamber-cover and integrated transport belt made from quartz-glass.

2A Vacuum pump with electrical or pneumatic vacuum- and injection valves for fresh air.

3A UV-C lamps with wave-length of 185 nm (nanometer) in the vacuum tube and 254 nm (nanometer) in the entry and exit area of the tunnel.

4A Transport belt, made of quartz-glass in the entry and exit of the tunnel.

5A Oxygen generator (centrifuge strainer principle).

6A Ozone-generator with corona cathodic discharge and 65% remaining oxygen.

7A Gas-tank for CO2 (carbondioxyde) with manometers and connection-tubing.

8A Gas-tank for Argon with manometers and connection-tubing.

9A Gas-mixer for gases with pressure regulator and manometer.

10A Evacuation pump for injection-gases.

11A Pressure-vessel for injection-gases for the intermediate storage and recovery with pressure regulator and manometers.

12A Ventilator to establish hypo baric conditions in the vacuum tunnel and for the evacuation of remaining gases.

13A Disinfections-gas ventilation turbine in vacuum chamber.

14A Electrical and pneumatic steering and control board.

15A Gas concentration measurement devices for Ozone, Oxygen, Carbondioxyde, and

Argon with Sensors in the Vacuum Chamber.

16A Ultrasound-Transducer.

In a second application of the process only a small underpressure of 600 to 800 mbar is created by means of an evacuation fan and the disinfection-gases are dissolved in water and the products to be disinfected are disinfected and washed by streaming water and spray-nozzles in the tunnel and afterwards dried by air or centrifuges.

This application can be done in a continuous flow-process.

In this second application of the invention the following technical main-components are preferentially necessary:

1B Immersion-washing tunnel with transport belt made from quartz-glass.

2B Ventilator-fan to create hypo baric conditions and to evacuate rest-gases which exit from the water.

3B UV-C Lamps with 185 nm (nanometers) wave length, mounted in the tunnel.

4B UV-C Lamps with 254 nm (nanometers) wave length, mounted in the entry and exit area of the water-tunnel.

5B Oxygen generator (from air by centrifuge strainer principle).

6B Ozone-generator with corona cathodic discharge and 65% remaining oxygen.

7B Gas-tank for CO2 with manometers and connection-tubing.

8B Gas-tank for Argon with manometers and connection-tubing.

9B Gas-mixer for 3 gases with pressure-regulator and manometer.

10B Water line with water inlet-valve in to the washing tunnel.

11B Drainage line with water siphon

12B Waterlines with water-nozzles in the tunnel.

13B Pressure compressor with tubes in the tunnel-water-bath with water nozzles for swirling the disinfection-water.

14B Water pressure pump.

15B Water-circulation pump with filter.

16B Venturi gas-injection-valve.

17B Gas-injector mixer.

18B Expansion vessel.

19B Pressure manometer before and after the expansion vessel.

20B Gas-concentration sensing device with probes in water for Ozone, Oxygen,

Carbondioxyde and Argon

21B Ventilation-dryer or centrifugal dryer after washing tunnel.

22B Electrical steering with control-board and programmable display.

23B Ultrasound-transducer.

### IMPLEMENTATION OF THE INVENTION

The application-method contains for the first application-version preferentially the following main-steps:

1. The product to be disinfected reaches in a batch-procedure via a conveyor belt, made from quartz-glass elements, the vacuum tunnel chamber. The conveyor belt is moved by an excenter rolling-shaker element up and down in such a way, that the transported goods are turned under the UV-C Lamps to all sites in such a way that the UV-C Light can reach all sections and parts of the product to be sterilized.

2. When the conveyor belt in the vacuum tunnel is full, the vacuum chamber is closed air tight hydraulically with the chamber-cover.

3. Afterwards a vacuum is created through the vacuum pump by extracting the atmospheric air down to a level of preferentially 50 to 200 mbar (mill bar).

4. After the vacuum has been established the gas-mix of Ozone, Oxygen, CO2 and Argon is automatically injected in the gas chamber up to an underpressure of approx. 750 mbar. The concentration of the injected gases is preferentially as follows: Ozone 15%, Oxygen 45%, Carbondioxyde 30% and Argon 10%.

5. During the injection of the disinfection-gases the product to be disinfected is bombarded with pulsed ultrasonic waves with minimum 20 kHz (kilo hertz) in intervals of preferably 5 seconds.

6. The gases remain approx. 30 seconds in the chamber.

7. Afterwards a new vacuum is created and the disinfection gas-mix is extracted through an electrical or pneumatical gas-valve, with a compressor pump, into the presume-vessel for recirculated disinfection gases, where the gas-mix is again reconstituted

in the right concentration by a sensor controlled gas-mixer.

The pressure vessel is connected with the gas-mixer and equalizes automatically the gas concentrations according to the settings with a sensory device.

8. After the evacuation of the disinfection gases the vacuum chamber is ventilated with fresh air, in such a way that there are no remnants of the disinfection gases left.

9. Afterwards the vacuum-chamber-cover is hydraulically lifted. The disinfection process is terminated.

10. The disinfected filling good is leaving the vacuum-tunnel automatically and runs on a conveyor belt made from quartz-glass elements through a UV-C light tunnel towards the filling packing-station. Through this, secondary infections on the product, via the air, are avoided.

11. The disinfected and sterile product reaches the aseptic packing station where it will be hermetically packed in bags, trays or boxes, scaled or shrinked with a foil.

The application-method for the second application consists preferentially for the implementation in the following main steps:

1. The product to be disinfected reaches, in a continuous process-flow, via a conveyor belt, made from quartz-glass elements, the washing tunnel.

The conveyor belt is moved by an excenter-rolling-shaker-element up and down in such a way, that the transported goods are turned under the UV-C lamps to all sites in such a way that the UV-C light can reach all sections and parts of the product to be sterilized.

2. In the washing tunnel, where, with a extraction blower, an underpressure is created, the product to be disinfected falls in the water in an immersion-process, enriched with Ozone,

Oxygen, Carbondioxyde and Argon where it is transported further on a conveyor Belt, made out of quartz-glass. Showers from water nozzles are simultaneously spraying those products, which are swimming on the surface of the water, in such a way that the disinfecting water has always a neat contact with the product. The disinfecting water-bath is swirled with compressed air through different nozzles in such a way that the product to be disinfected is coming in contact by immersion with the disinfection gases in the continuous swirled water.

3. The disinfection process lasts according to the type of product and concentration of the dissolved gases in the water for approx. 2 to 6 minutes and can be programmed.

4. In front and after the water-bath UV-C lamps with 185 nm (nanometer) and 254 nm (nanometer are fixed in a light-tunnel.

5. In and over the water-bath, inside the disinfection tunnel, the product passes at the same time a ring of ultrasound, which is working with pulses, with a frequency of preferentially minimal 20 to 100 kHz (kilo herz). Hereby the product is bombarded at the same time with ultrasonic waves and irradiated with UV-C light and is exposed to biocidal gases.

6. The immersion-process in the water-bath of the products to be treated can be performed either in loose condition or with a plastic-crate process.

7. After the passage through the wet disinfection tunnel the disinfected product reaches, still under UV-C irradiation on the conveyor belt, made out of quartz-glass, a sterile air-jet air-dryer or a centrifugal dryer.

8. Afterwards the product is packed under aseptic sterile conditions.

The new sterilization process has shown excellent results in laboratory as well as in industrial applications.

During 10 years of research- and development-work the process has been brought to market maturity.

The new process with his specific new technical concept is not only very well functioning with food stuff, but also for instance with pharmaceutical products and in medical applications.

1. Process and technological implementation for the disinfection and conservation of fruits and vegetables, food stuff of all kinds, horticultural and agricultural products and other products by fumigation or washing in water with the use of Ozone, Oxygen, Carbondioxyde and Argon and with the simultaneous application of UV-C irradiation, Ultrasound and Vacuum.

2. Disinfection process, according to claim 1, characterized in, that the process can be implemented not only in the version 1 by fumigation but also in the version 2 by the water-washing process.

3. Disinfection process, according to claim 1, characterized in, that in the version 1, in the batch-process, a Vacuum is created, additional to the disinfection gases Ozone, Oxygen, Carbondioxyde, Argon, UV-C Irradiation and Ultrasound.

4. Disinfection process, according to claim 1, characterized in that in the version 2, in the product-flow-process in the water-tunnel, in addition to the disinfection gases Ozone, Oxygen, Carbondioxyde, Argon, UV-C Irradiation and Ultrasound, only a partial vacuum (underpressure) will be established.

5. Disinfection process, according to claim 1, characterized in, that the UV-C irradiation of the products to be disinfected is happening at the same time with the application of the disinfection gases and the ultrasound as well inside, as before and after the disinfection tunnel, in the vacuum chamber, and in the water-bath.

6. Disinfection process, according to claim 1, characterized in, that the products to be disinfected, are treated as well with Ultrasound, simultaneously with the application of disinfection gases and UV-C irradiation.

7. Disinfection process, according to claim 1, characterized in, that for the technical implementation of version 1 the following main components and equipments are preferentially used:
1A Vacuum-tunnel with hydraulic vacuum-chamber-cover and integrated transport belt made from quartz-glass,
2A Vacuum pump with electrical or pneumatic vacuum- and injection valves for fresh air,
3A UV-C lamps with wave-length of 185 nm (nanometer) in the vacuum tube and 254 nm (nanometer) in the entry and exit area of the tunnel,
4A Transport belt made of quartz-glass in the entry- and exit-tunnel,
5A Oxygen generator (centrifuge strainer principle),
6A Ozone-generator with corona cathodic discharge and 65% remaining oxygen,
7A Gas-tank for CO2 (carbondioxyde) with manometers and connection-tubing,
8A Gas-tank for Argon with manometers and connection-tubing,
9A Gas-mixer for gases with pressure regulator and manometer,
10A Evacuation pump for injection-gases,
11A Pressure-vessel for injection-gases for the intermediate storage and gas-recovery with pressure regulator and manometers,
12A Ventilator to establish hypo baric conditions in the vacuum tunnel and for the evacuation of remaining gases,
13A Disinfection-gas ventilation turbine in vacuum chamber,
14A Electrical and pneumatic steering and control board,
15A Gas concentration measurement devices for Ozone, Oxygen, Carbondioxyde, and Argon with sensors in the vacuum chamber,
16A Ultrasound-Transducer.

8. Disinfection process, according to claim 1, characterized in, that for the technical implementation of version 2, the following main components and equipment are preferentially used:
1B Immersion-washing tunnel made from coated stainless-steel with transport belt made from quartz-glass,
2B Ventilator-fan to create hypo baric conditions and to evacuate rest-gases which exit from the water,
3B UV-C Lamps with 185 nm (nanometers) wave length, mounted in the tunnel,
4B UV-C Lamps with 254 nm (nanometers) wave length, mounted in the entry and exit area of the water-tunnel,
5B Oxygen generator (from air by centrifuge strainer principle),
6B Ozone-generator with corona cathodic discharge and 65% remaining oxygen,
7B Gas-tank for CO2 (carbondioxyde) with manometers and connection-tubing,
8B Gas-tank for Argon with manometers and connection-tubing,
9B Gas-mixer for 3 gases with pressure-regulator and manometer and connection-tubing,
10B Water line with water inlet-valve in to the washing tunnel,
11B Drainage line with water siphon in the washing tunnel,
12B Waterlines with water-nozzles and value in the tunnel,
13B Pressure compressor with tubes in the tunnel-water-bath with water nozzles for swirling the disinfection-water,
14B Water pressure pump with tubing,
15B Water-circulation pump with filter and tubing,
16B Venturi gas-injection-valve and tubing,
17B Gas-injector mixer with connection tubing,
18B Expansion vessel with connection tubing,
19B Pressure manometer before and after the expansion vessel,
20B Gas-concentration sensing device with probes in water for Ozone, Oxygen, Carbondioxyde and Argon
21B Ventilation-dryer or centrifugal dryer after washing tunnel,
22B Electrical steering with switch-control-board and programmable display,
23B Ultrasound-transducer.

9. Disinfection process, according to claim 6, characterized in that the inner walls of the Vacuum-Gas-Tunnel and of the Water-Tunnel are equipped with a coating of a special PVC or another suitable material which allows the unproblematic use of Ultrasound.

10. Process and technical implementation for the disinfection and conservation of food stuff of all kinds, and other products, according to claim 1 by means of fumigation or washing, using Ozone, Oxygen, Carbondioxyde and Argon and by means of simultaneous applications of UV-C Irradiation, Ultrasound and Vacuum or Underpressure, with the use of the described specific technical main-components, equipments and the corresponding technical engineering.

11. Disinfection process, according to claim 2, characterized in, that in the version 1, in the batch-process, a Vacuum is created, additional to the disinfection gases Ozone, Oxygen, Carbondioxyde, Argon, UV-C Irradiation and Ultrasound.

12. Disinfection process, according to claim 2, characterized in that in the version 2, in the product-flow-process in the water-tunnel, in addition to the disinfection gases Ozone, Oxygen, Carbondioxyde, Argon, UV-C Irradiation and Ultrasound, only a partial vacuum (underpressure) will be established.

13. Disinfection process, according to claim 2, characterized in, that the UV-C irradiation of the products to be disinfected is happening at the same time with the application of the disinfection gases and the ultrasound as well inside, as before and after the disinfection tunnel, in the vacuum chamber, and in the water-bath.

14. Disinfection process, according to claim 3, characterized in, that the UV-C irradiation of the products to be disinfected is happening at the same time with the application of the disinfection gases and the ultrasound as well inside, as before and after the disinfection tunnel, in the vacuum chamber, and in the water-bath.

15. Disinfection process, according to claim 4, characterized in, that the UV-C irradiation of the products to be disinfected is happening at the same time with the application of the disinfection gases and the ultrasound as well inside, as before and after the disinfection tunnel, in the vacuum chamber, and in the water-bath.

16. Disinfection process, according to claim 2, characterized in, that the products to be disinfected, are treated as well with Ultrasound, simultaneously with the application of disinfection gases and UV-C irradiation.

17. Disinfection process, according to claim 3, characterized in, that the products to be disinfected, are treated as well with Ultrasound, simultaneously with the application of disinfection gases and UV-C irradiation.

18. Disinfection process, according to claim 4, characterized in, that the products to be disinfected, are treated as well with Ultrasound, simultaneously with the application of disinfection gases and UV-C irradiation.

19. Disinfection process, according to claim 5, characterized in, that the products to be disinfected, are treated as well with Ultrasound, simultaneously with the application of disinfection gases and UV-C irradiation.

20. Disinfection process, according to claim 2, characterized in, that for the technical implementation of version 1 the following main components and equipments are preferentially used:
1A Vacuum-tunnel with hydraulic vacuum-chamber-cover and integrated transport belt made from quartz-glass,
2A Vacuum pump with electrical or pneumatic vacuum- and injection valves for fresh air,
3A UV-C lamps with wave-length of 185 nm (nanometer) in the vacuum tube and 254 nm (nanometer) in the entry and exit area of the tunnel,
4A Transport belt made of quartz-glass in the entry- and exit-tunnel,
5A Oxygen generator (centrifuge strainer principle),
6A Ozone-generator with corona cathodic discharge and 65% remaining oxygen,
7A Gas-tank for CO2 (carbondioxyde) with manometers and connection-tubing,
8A Gas-tank for Argon with manometers and connection-tubing,
9A Gas-mixer for gases with pressure regulator and manometer,
10A Evacuation pump for injection-gases,
11A Pressure-vessel for injection-gases for the intermediate storage and gas-recovery with pressure regulator and manometers,
12A Ventilator to establish hypo baric conditions in the vacuum tunnel and for the evacuation of remaining gases,
13A Disinfection-gas ventilation turbine in vacuum chamber,
14A Electrical and pneumatic steering and control board,
15A Gas concentration measurement devices for Ozone, Oxygen, Carbondioxyde, and Argon with sensors in the vacuum chamber,
16A Ultrasound-Transducer.
